(19) United States
(12) Patent Application Publication
(10) Pub. No.: US 2008/0115891 A1
(43) Pub. Date: May 22, 2008

(54) Laser beam machining system

(75) Inventors: Masanori Yoshida, Ota-ku (JP); Satoshi Genda, Ota-ku (JP); Toshio Tsuchiya, Ota-ku (JP)

Correspondence Address: GREER, BURNS & CRAIN, 300 S WACKER DR, 25TH FLOOR, CHICAGO, IL, 60606, US

(73) Assignee: Disco Corporation, Tokyo (JP)

(21) Appl. No.: 11/986,318

(22) Filed: Nov. 20, 2007

(30) Foreign Application Priority Data
Nov. 21, 2006 (JP) 2006-314329

(51) Int. Cl. C23F 1/08; B05C 13/00; B05C 9/10; B05C 9/12; B23K 26/36

(52) U.S. Cl. 156/345.23; 156/345.54

(57) ABSTRACT

A laser beam machining system includes: a chuck table for holding a wafer; a laser beam irradiation unit for irradiating the wafer held by a chuck table with a laser beam; a machining feeding unit for machining feed of the chuck table; and an indexing feeding unit for indexing feed of the chuck table, wherein the system further includes etching unit for etching the wafer having undergone laser beam machining, and a feeding unit for feeding the laser beam machined wafer held on the chuck table to the etching unit.

### BACKGROUND OF THE INVENTION

1. Field of the Invention

The present invention relates to a laser beam machining system for irradiating a wafer with a laser beam along planned split lines formed in the wafer and then splitting the wafer along the planned split lines.

2. Description of the Related Art

In a semiconductor device manufacturing process, a plurality of regions are demarcated by planned split lines (called “streets”) arranged in a lattice pattern in a surface of a substantially circular disk-shaped semiconductor wafer, and devices such as ICs and LSIs are formed in the thus demarcated regions. Then, the semiconductor wafer is cut along the streets so as to split the regions provided with the devices from each other, thereby manufacturing individual semiconductor chips. In addition, an optical device wafer in which a gallium nitride based compound semiconductor or the like is stacked on a surface of a sapphire substrate is also cut along the streets, whereby the optical device wafer is split into individual optical devices such as photo-diodes, laser diodes, etc., which are widely used in electric apparatuses.

The cutting (dicing) along the streets in such a wafer, e.g., semiconductor wafer or optical device wafer, is normally carried out by use of a cutting (machining) apparatus. The cutting apparatus includes cutting means for cutting the wafer held by the chuck table, and moving means for effecting a relative movement of the chuck table and the cutting means. The cutting means includes a rotary spindle rotated at a high speed, and a cutting blade mounted to the spindle. In the cutting of the wafer by such a cutting apparatus, the feed rate has its limit, and the generation of cuttings would lead to contamination of the chips.

On the other hand, as a method for splitting a plate-shaped work such as a semiconductor wafer, in recent years, there has been proposed a method in which the work is irradiated with a pulsed laser beam along planned split lines formed in a surface of the work so as to cut the work through ablation machining (refer to, for example, Japanese Patent Laid-open No. Hei 10-305420).

However, when the wafer is cut by the above-mentioned laser beam machining method, machining strains would be left at the peripheral surfaces of the individual chips obtained upon the cutting, resulting in that the chips show a lowered transverse rupture strength. Particularly, in the case of the gallium arsenide (GaAs) wafer which normally is low in transverse rupture strength, the influence of the residual machining strains on the lowering in transverse rupture strength is heavy.

On the other hand, machining strains are left at the peripheral surfaces of the individually split devices obtained upon cutting of a wafer along the planned split lines by the cutting apparatus. For removing the machining strains, there has been proposed a wafer machining method in which the splitting of a wafer into individual devices is followed by chemical etching (refer to, for example, Japanese Patent Laid-open No. Hei 7-161665). However, to carry out a process in which the wafer split into individual devices by use of the cutting apparatus is subjected to the etching treatment, a feeding step in which the wafer split into the individual devices is fed to an etching apparatus by a feeding equipment is needed, which is unsatisfactory from the viewpoint of productivity.

### SUMMARY OF THE INVENTION

Accordingly, it is an object of the present invention to provide a laser beam machining system such that after a wafer is irradiated with a laser beam along planned split lines so as to split the wafer into individual devices, and the individual devices can be immediately subjected to an etching treatment without being fed to an etching apparatus.

In accordance with an aspect of the present invention, there is provided a laser beam machining system including: a chuck table for holding a wafer; laser beam irradiation means for irradiating the wafer held by the chuck table with a laser beam; machining feeding means for relative machining feed of the chuck table and the laser beam irradiation means; indexing feeding means for relative indexing feed of the chuck table and the laser beam irradiation means in a direction orthogonal to the direction of the machining feed; an etching means for etching the wafer having undergone laser beam machining; and feeding means for feeding the laser beam machined wafer held by the chuck table to the etching means.

Preferably, the etching means includes a spinner table for holding and spinning the wafer, and etching liquid supplying means for supplying an etching liquid to the laser beam machined wafer held by the spinner table. The etching means, preferably, has protective material supplying means for supplying a liquid protective material for forming a protective film on the side to be machined of the wafer not yet laser beam machined which is held by the spinner table. In addition, the etching means preferably has cleaning water supplying means for supplying cleaning water for cleaning the etched wafer held by the spinner table.

The wafer to be machined by the laser beam machining system may be a gallium arsenide (GaAs) wafer, and the etching liquid used for the etching by the etching means may include ammonium hydroxide and hydrogen peroxide.

The laser beam machining system according to the present invention includes the etching means for etching the laser beam machined wafer, and the feeding means for feeding the laser beam machined wafer held by the chuck table to the etching means, and, therefore, the laser beam machined wafer can immediately be subjected to an efficient etching treatment.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a laser beam machining system configured according to the present invention;

FIG. 2 is a partly broken perspective view of combined etching and cleaning and protective film forming means provided in the laser beam machining system shown in FIG. 1;

FIG. 3 illustrates the condition where a spinner table in the combined etching and cleaning and protective film forming means shown in FIG. 2 is positioned in a work feeding-in/feeding-out position;

FIG. 4 illustrates the condition where the spinner table in the combined etching and cleaning and protective film forming means shown in FIG. 2 is positioned in a working position;

FIG. 5 is a perspective view of a gallium arsenide wafer as a work to be machined by the laser beam machining system shown in FIG. 1;

FIGS. 6A and 6B illustrate a protective film forming step carried out by use of the laser beam machining system shown in FIG. 1;

FIGS. 7A and 7B illustrate a laser beam machining step carried out by use of the laser beam machining system shown in FIG. 1;

FIG. 8 is an enlarged sectional view of an essential part of a gallium arsenide wafer provided with laser beam machined grooves by the laser beam machining step shown in FIGS. 7A and 7B;

FIG. 9 is an enlarged sectional view of an essential part of the gallium arsenide wafer, showing the condition where the laser beam machined groove formed by the laser beam machining step shown in FIGS. 7A and 7B has reached a protective tape; and

FIG. 10 illustrates an etching step carried out by use of the laser beam machining system shown in FIG. 1.

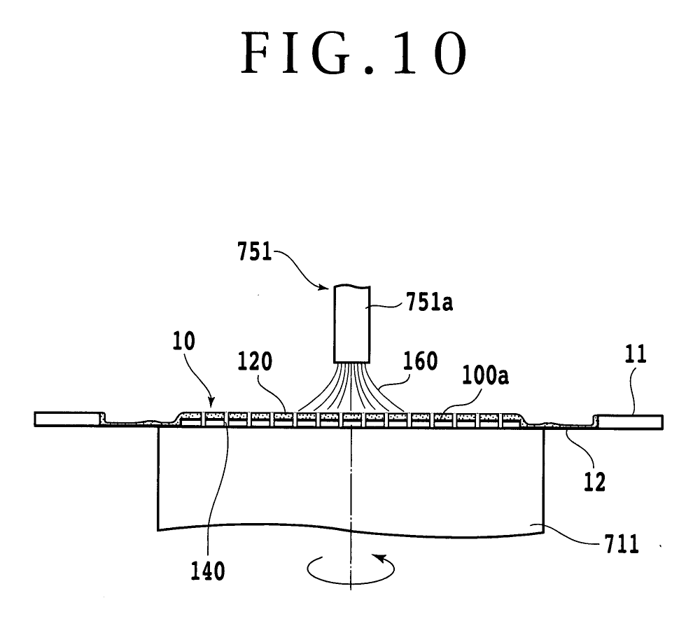

### DETAILED DESCRIPTION OF THE PREFERRED EMBODIMENTS

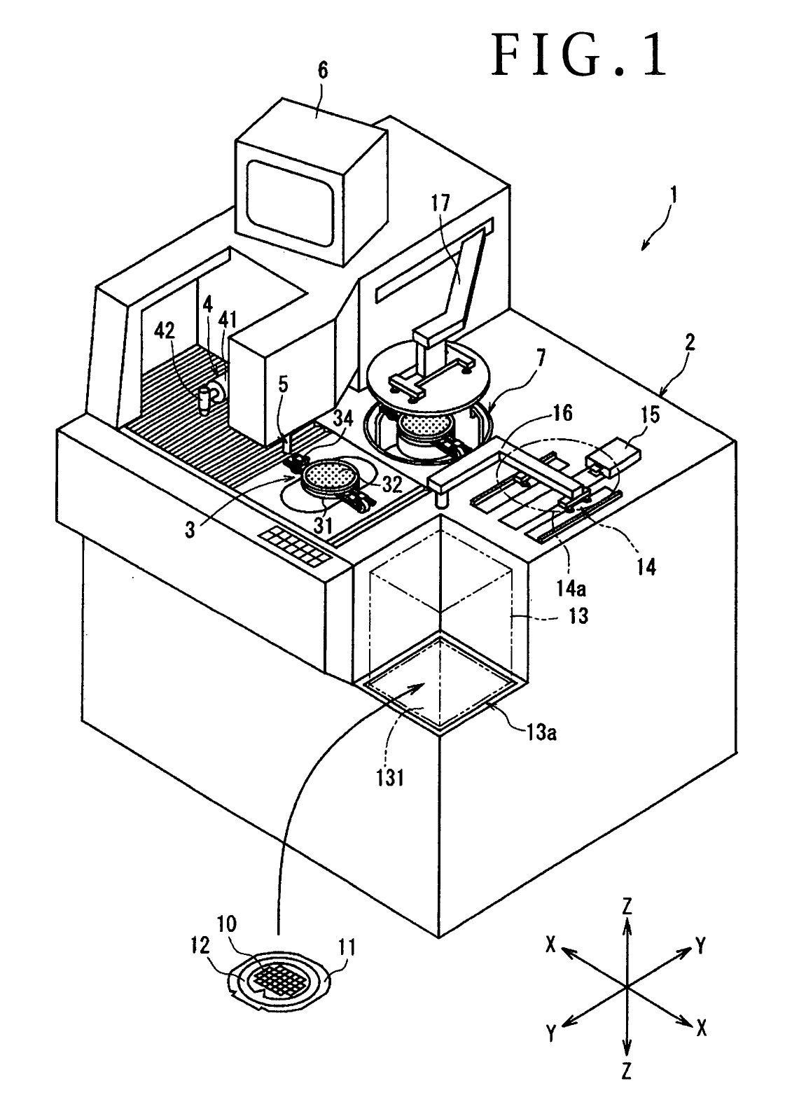

Now, a preferred embodiment of a laser beam machining system configured according to the present invention will be described in detail below, referring to the attached drawings. FIG. 1 shows a perspective view of the laser beam machining system configured according to the present invention. The laser beam machining system 1 shown in FIG. 1 has a substantially rectangular parallelopiped system housing 2. In the system housing 2, a chuck table 3 for holding a wafer as a work is disposed to be movable in a machining feed direction indicated by arrow X and in an indexing feed direction Y orthogonal to the machining feed direction X. The chuck table 3 has a suction chuck support base 31, and a suction chuck 32 mounted on the suction chuck support base 31, and the wafer as a work is held on the face, or mount surface, of the suction chuck 32 by the action of suction means (not shown). In addition, the chuck table 3 is configured to be turnable by a rotating mechanism (not shown). Clamps 34 for fixing an annular frame to be described later is disposed at the suction chuck support base 31 of the chuck table 3 thus configured. Incidentally, the laser beam machining system 1 includes machining feeding means (not shown) for machining feed of the chuck table 3 in the machining feed direction X, and indexing feed means (not shown) for indexing feed of the chuck table 3 in the indexing feed direction Y.

The laser beam machining system 1 shown in the figure has laser beam irradiation means 4 for applying laser beam machining to the wafer which is held as a work by the chuck table 3. The laser beam irradiation means 4 has laser beam oscillating means 41, and a condenser 42 for condensing the laser beam oscillated by the laser beam oscillating means 41. Incidentally, the laser beam machining system 1 has moving means (not shown) for moving the laser beam oscillating means 41 in a condensing point position control direction of arrow Z, which is a direction perpendicular to the upper surface, or the mount surface, of the chuck table 3.

The laser beam machining system 1 shown in the figure has image pickup means 5 for picking up an image of the surface of the work held on the suction chuck 32 of the chuck table 3 and detecting a region to be machined by the laser beam radiated from the condenser 42 of the laser beam irradiation means 4. The image pickup means 5 includes not only a normal image pickup device (CCD) for picking up an image by use of visible rays but also IR illumination means for irradiating the work with IR rays, an optical system for catching the IR rays radiated from the IR illumination means, an image pickup device (infrared CCD) for outputting an electrical signal corresponding to the IR rays caught by the optical system, etc., and sends a picture signal of the picked-up image to control means (described later). In addition, the laser beam machining means 1 shown in the figure has display means 6 for displaying the image picked up by the image pickup means 5.

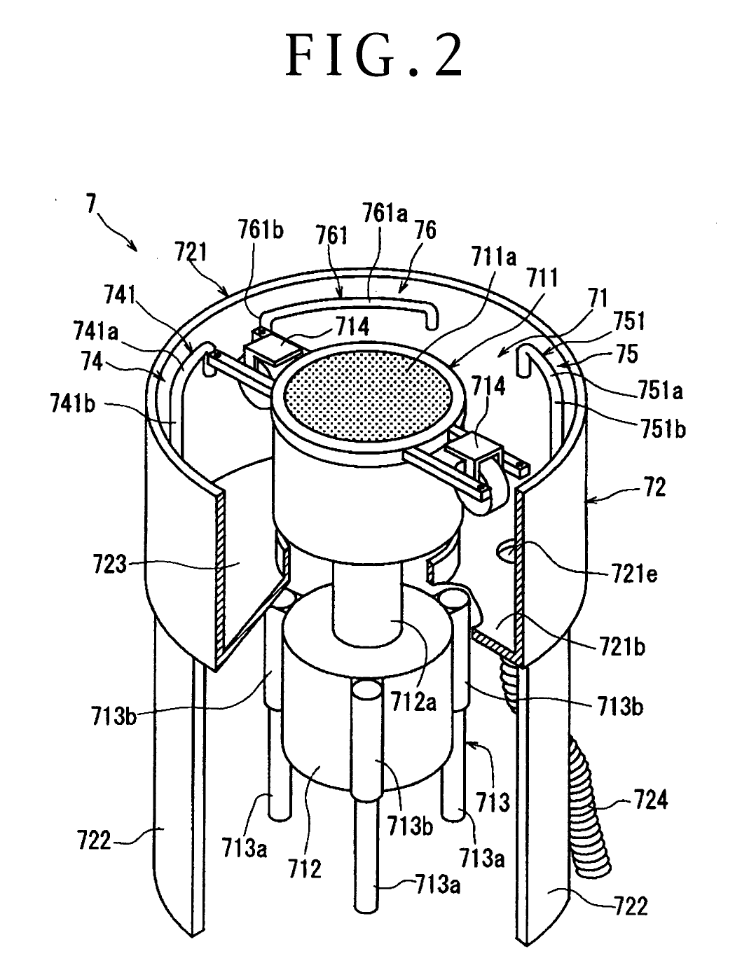

The laser beam machining system 1 shown in the figure has combined etching and cleaning and protective film forming means 7 having a function as etching means for applying an etching treatment to the wafer having undergone laser beam machining, a function as cleaning means for cleaning the wafer having undergone the etching treatment, and a function as protective film forming means for coating the surface to be machined of the wafer not yet subjected to the laser beam machining with a protective film. The combined etching and cleaning and protective film forming means 7 will be described referring to FIGS. 2 to 4.

The combined etching and cleaning and protective film forming means 7, in the embodiment shown, has a spinner table mechanism 71, and etching liquid receiving means 72 disposed to surround the spinner table mechanism 71. The spinner table mechanism 71 includes a spinner table 711, an electric motor 712 for rotationally driving the spinner table 711, and a support mechanism 713 for supporting the electric motor 712 in a vertically movable manner. The spinner table 711 has a suction chuck 711a formed from a porous material, and the suction chuck 711a communicates with suction means (not shown). Therefore, the spinner table 711 is so configured that a wafer as a work is held on the suction chuck 711 by mounting the wafer on the suction chuck 711a and applying a negative pressure to the wafer by the suction means (not shown). Incidentally, clamp mechanisms 714 for fixing an annular frame (described later) are disposed at the spinner table 711.

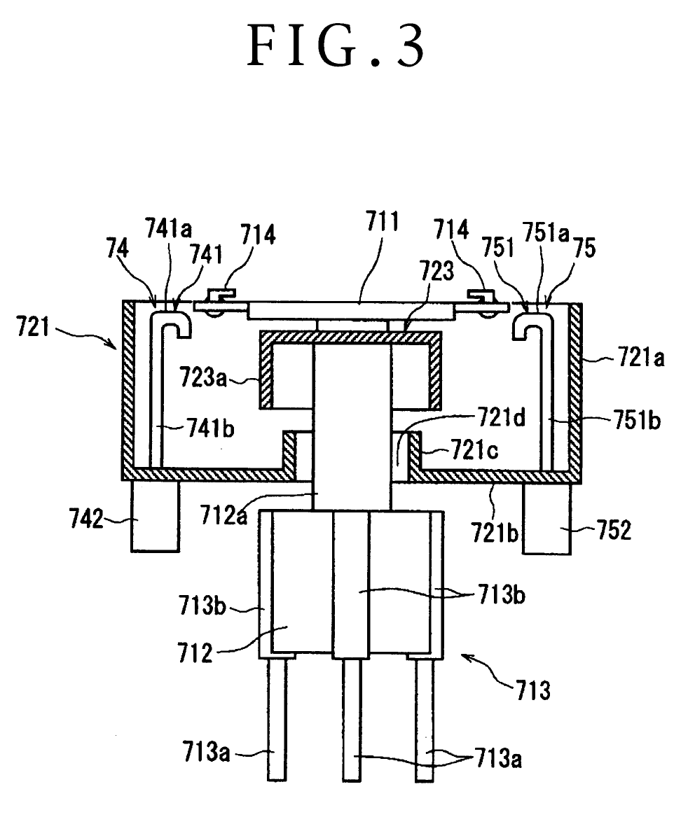

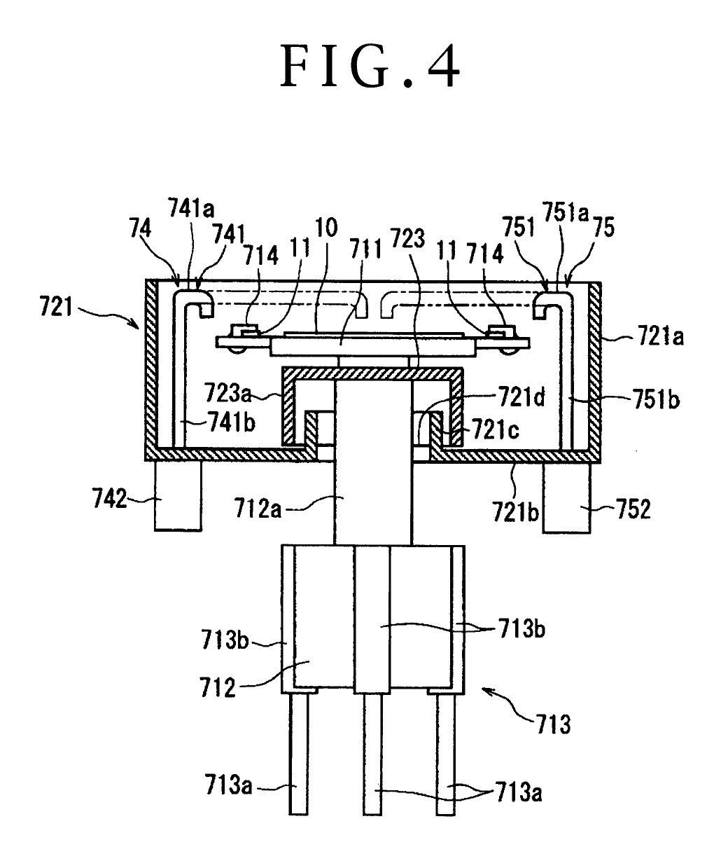

The electric motor 712 has a drive shaft 712a, to the upper end of which the spinner table 711 is connected. The support mechanism 713 is composed of a plurality of (in the embodiment shown, three) support legs 713a, and a plurality of (in the embodiment shown, three) air cylinders 713b to which the support legs 713a are connected respectively and which are attached to the electric motor 712. With the support mechanism 713 thus configured, the electric motor 712 and the spinner table 711 are located in a work feeding-in/feeding-out position, which is an upper position shown in FIG. 3, and a working position, which is a lower position shown in FIG. 4, by operating the air cylinders 713b.

The etching liquid receiving means 72 includes an etching liquid receiving vessel 721, three support bases 722 (two of them are shown in FIG. 2) for supporting the etching liquid receiving vessel 721, and a cover member 723 mounted to the drive shaft 712a of the electric motor 712. The etching liquid receiving vessel 721 is comprised of a hollow cylindrical outside wall 721a, a bottom wall 721b and an inside wall 721c, as shown in FIGS. 3 and 4. The bottom wall 721b is provided in its central part with a hole 721d through which to pass the drive shaft 712a of the electric motor 712, and the inside wall 721c projects upward from the circumferential edge of the hole 721d. In addition, as shown in FIG. 2, the bottom wall 721b is provided with a drain hole 721e, and a drain hose 724 is connected to the drain hole 721e. The cover member 723 is circular disk-like in shape, and has a cover part 723a projecting downward from the peripheral edge thereof. With the cover member 723 thus configured, when the electric motor 712 and the spinner table 711 are located in the working position shown in FIG. 4, the cover part 723a is located on the outside of and in the manner of overlapping with the inside wall 721c constituting the etching liquid receiving vessel 721, with a gap therebetween.

The combined etching and cleaning and protective film forming means 7, in the embodiment shown, has protective material supplying means 74 for supplying a liquid protective material such as polyvinyl alcohol (PVA) to the surface to be machined of the wafer, or work, not yet laser beam machined which is held on the spinner table 711. The protective material supplying means 74 includes a protective material supply nozzle 741 for supplying the liquid protective material to the surface to be machined of the not-yet-machined wafer held on the spinner table 711, and an electric motor 742 capable of rotating normally and reversely and operative to swing the protective material supply nozzle 741, and the protective material supply nozzle 741 is connected to a protective material supply source (not shown).

The protective material supply nozzle 741 is composed of a nozzle part 741a extending horizontally, and a support part 741b extending downward from the nozzle part 741a, and the support part 741b is disposed to pass through a passing hole (not shown) provided in the bottom wall 721b constituting the etching liquid receiving vessel 721 and is connected to the protective material supply source (not shown). Incidentally, to the circumferential edge of a passing hole (not shown) through which to pass the support part 741b of the protective material supply nozzle 741, a seal member (not shown) for sealing the gap between the circumferential edge and the support part 741b is mounted.

The combined etching and cleaning and protective film forming means 7, in the embodiment shown, has etching liquid supplying means 75 for applying an etching treatment to the wafer, or work, having undergone laser beam machining which is held on the spinner table 711. The etching liquid supplying means 75 includes an etching liquid nozzle 751 for jetting an etching liquid toward the laser beam machined wafer held on the spinner table 711, and an electric motor 752 capable of rotating normally and reversely and operative to swing the etching liquid nozzle 751, and the etching liquid nozzle 751 is connected to an etching liquid supply source (not shown).

The etching liquid nozzle 751 is composed of a nozzle part 751a extending horizontally and having a tip part bent downward, and a support part 751b extending downward from the base end of the nozzle part 751a, and the support part 751b is disposed to pass through a passing hole (not shown) provided in the bottom wall 721b constituting the etching liquid receiving vessel 721 and is connected to the etching liquid supply source (not shown). Incidentally, to the circumferential edge of the passing hole (not shown) through which to pass the support part 751b of the etching liquid nozzle 751, a seal member (not shown) for sealing the gap between the circumferential edge and the support part 751b is mounted.

The combined etching and cleaning and protective film forming means 7, in the embodiment shown, has a cleaning water supplying means 76 for cleaning the wafer, or work, having undergone the etching treatment which is held on the spinner table 711. The cleaning water supplying means 76 includes a cleaning water nozzle 761 for jetting cleaning water toward the etched wafer held on the spinner table 711, and an electric motor (not shown) capable of rotating normally and reversely and operative to swing the cleaning water nozzle 761, and the cleaning water nozzle 761 is connected to a cleaning water supply source (not shown).

The cleaning water nozzle 761 is composed of a nozzle part 761 extending horizontally and having a tip part bent downwards, and a support part 761b extending downward from the base end of the nozzle part 761a, and the support part 761b is passed through a passing hole (not shown) provided in the bottom wall 721b constituting the etching liquid receiving vessel 721 and is connected to the cleaning water supply source (not shown). Incidentally, to the circumferential edge of the passing hole (not shown) through which to pass the support part 751b of the cleaning water nozzle 751, a seal member (not shown) for sealing the gap between the circumferential edge and the support part 751b is mounted.

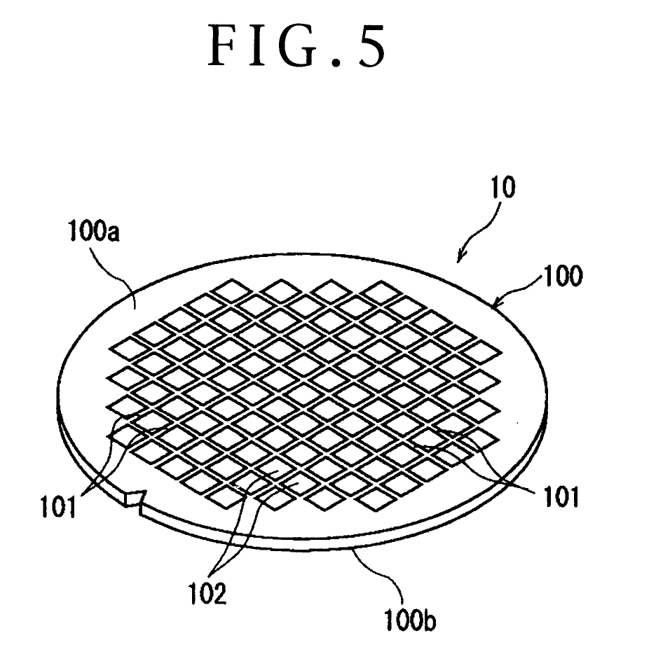

Returning to FIG. 1, the laser beam machining system shown has a cassette mount part 13a on which to mount a cassette for containing gallium arsenide wafers 10 as the wafers, or works. The cassette mount part 13a is provided with a cassette table 131 which can be moved vertically by a lift means (not shown), and the cassette 13 is mounted on the cassette table 131. Each of the gallium arsenide wafers 10 is adhered to the face side of a protective tape 12 mounted to an annular frame 11, and is contained in the cassette 13 in the state of being supported by the annular frame 11 through the protective tape 12. As shown in FIG. 5, the gallium arsenide wafer 10 has a configuration in which a plurality of planned split lines 101 is formed in a lattice pattern on the face side 100a of a gallium arsenide (GaAs) substrate 100 having a thickness of 100 μm, for example. On the face side 100a of the gallium arsenide (GaAs) substrate 100, devices 102 such as hybrid ICs and high-speed ICs are formed in a plurality of regions demarcated by the plurality of planned split line 101 formed in a lattice pattern. As shown in FIG. 1, the back side of the gallium arsenide wafer 10 thus configured is adhered to the protective tape 12 mounted to the annular frame 11, in the condition where the face side 100a thereof, namely, the surface provided with the planned split lines 101 and the devices 102, is on the upper side.

The laser beam machining system 1 shown includes: wafer feeding-out/feeding-in means 15 for feeding out the not-yet-machined gallium arsenide wafer 10 contained in the cassette 13 to aligning means 14 disposed in a temporary placing part 14a, and for feeding in the machined gallium arsenide wafer 10 into the cassette 13; first wafer feeding means 16 for feeding the not-yet-machined gallium arsenide wafer 10, fed out to the aligning means 14, to the combined etching and cleaning and protective film forming means 7, and for feeding the gallium arsenide wafer 10 with the face side coated with a protective film by the combined etching and cleaning and protective film forming means 7 onto the chuck table 3; and second wafer feeding means 17 for feeding the gallium arsenide wafer 10 having undergone laser beam machining on the chuck table 3 to the combined etching and cleaning and protective film forming means 7.

The laser beam machining system 1 shown is configured as above. Now, a laser beam machining method for cutting the gallium arsenide wafer 10 along the planned split lines 101 formed in the face side 100a of the substrate 100 of the wafer 10 by use of the laser beam machining system 1 will be described below. The not-yet-machined gallium arsenide wafer 10 supported on the annular frame 11 through the protective tape 12 as shown in FIG. 1 (hereinafter referred to simply as the gallium arsenide wafer 10) is contained at a predetermined position in the cassette 13, with its face side 100a, i.e. the surface to be machined, on the upper side. The not-yet-machined gallium arsenide wafer 10 contained at a predetermined position in the cassette 13 is positioned into a feeding-out position through moving the cassette table 131 vertically by the lift means (not shown). Next, the wafer feeding-out/feeding-in means 15 is moved forward or backward, whereby the gallium arsenide wafer 10 positioned in the feeding-out position is fed out to the aligning means 14 disposed at the temporary placing part 14a. The gallium arsenide wafer 10 fed out to the aligning means 14 is aligned to a predetermined position by the aligning means 14.

Subsequently, the not-yet-machined semiconductor wafer 10 aligned by the aligning means 14 is fed onto the suction chuck 711a of the spinner table 711 constituting the combined etching and cleaning and protective film forming means 7 by a slewing operation of the first wafer feeding means 16, and is held by suction onto the suction chuck 711a (wafer holding step). In addition, the annular frame 11 is fixed by the clamps 714. In this instance, the spinner table 711 is located in the work feeding-in/feeding-out position shown in FIG. 3, and the protective material supplying nozzle 741 and the cleaning water nozzle 751 as well as the air nozzle 761 are located in stand-by positions remote from the positions on the upper side of the spinner table 711, as shown in FIGS. 2 and 3.

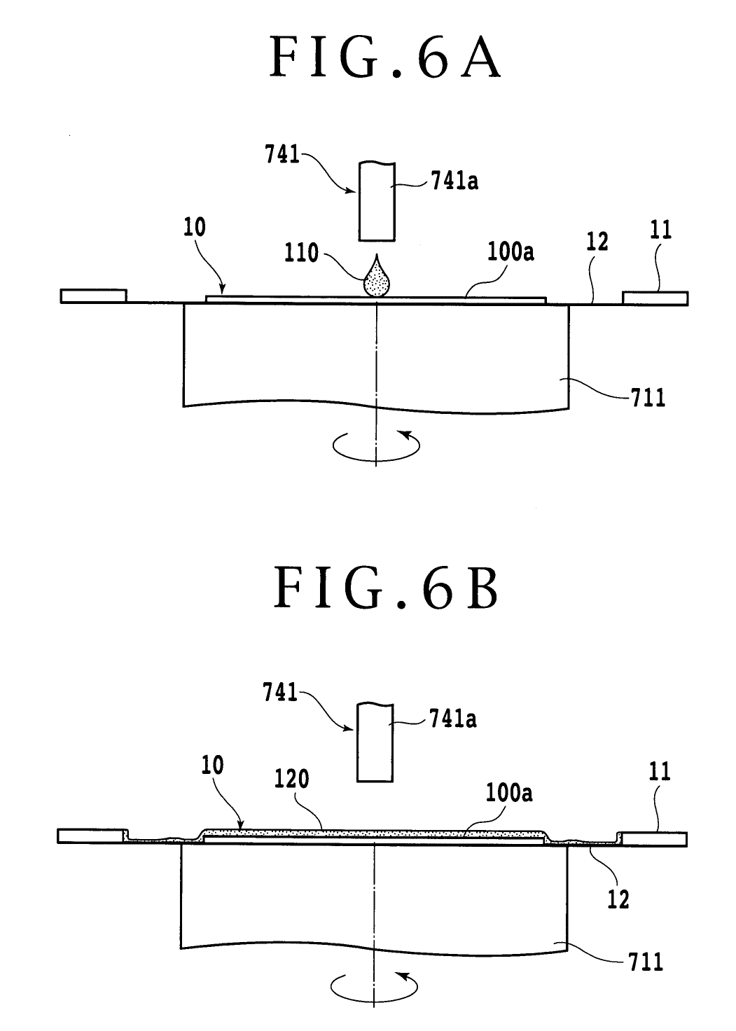

When the wafer holding step for holding the not-yet-machined gallium arsenide wafer 10 on the spinner table 711 of the combined etching and cleaning and protective film forming means 7 is completed, a protective film forming step for forming a protective film in the manner of coating the face side 100a, or the surface to be machined, of the semiconductor wafer 10 held on the spinner table 711. More specifically, the spinner table 711 is positioned into a working position, and the electric motor 742 of the protective material supplying means 74 is actuated to position a jet port of the nozzle part 741a of the protective material supplying nozzle 741 into a position on the upper side of a central part of the gallium arsenide wafer 10 held on the spinner table 711, as shown in FIG. 6A. Then, while rotating the spinner table 711 in the direction of arrow at a predetermined rotating speed (for example, 200 rpm), a predetermined amount (for example, 1 cc in the case where the diameter of the semiconductor wafer 10 is 200 mm) of the liquid protective material 110 is dropped from the protective material supplying nozzle 741 of the protective material supplying means 74 down to a central region of the face side 1001 (the surface to be machined) of the gallium arsenide wafer 10 adhered to the face side of the protective tape 12 mounted to the annular frame 11. Incidentally, the liquid protective material is preferably a water-soluble resist such as polyvinyl alcohol (PVA).

Thus, 1 cc of the liquid protective material 110 such as polyvinyl alcohol is dropped to the central region of the face side 100a (the surface to be machined) of the not-yet-machined gallium arsenide wafer 10 held on the spinner table 711, and the spinner table 711 is rotated at a rotating speed of 200 rpm for about 60 sec, whereby the face side 100a (the surface to be machined) of the semiconductor wafer 10 is coated with a protective film 120 having a thickness of about 1 μm, as shown in FIG. 6B.

When the protective film forming step is over, the spinner table 711 is positioned into the work feeding-in/feeding-out position shown in FIG. 3, and the holding by suction of the gallium arsenide wafer 10 held on the spinner table 711 is released (canceled). Then, the gallium arsenide wafer 10 on the spinner table 711 is fed onto the suction chuck 32 of the chuck table 3 by the first wafer feeding means 16, and is held onto the suction chuck 32 by suction. The chuck table 3 with the gallium arsenide wafer 10 thus held thereon by suction is positioned directly under the image pickup means 5 disposed in the laser beam irradiation means 4, by machining feeding means (not shown).

When the chuck table 3 is thus positioned directly under the image pickup means 5, an image treatment such as pattern matching for aligning between the planned split lines 101 formed in a predetermined direction in the gallium arsenide wafer 10 and the condenser 42 of the laser beam irradiating means 4 for irradiation with a laser beam along the planned split lines 101 is carried out by the image pickup means 5 and control means (not shown), whereby alignment of the laser beam irradiation position is performed. In addition, similar alignment of laser beam irradiation position is carried out also for the planned split lines 101 extending perpendicularly to the above-mentioned predetermined direction which are formed in the gallium arsenide wafer 10. In this case, the protective coating film 110 is formed on the face side 100a provided with the planned split lines 101 of the gallium arsenide wafer 10, and, where the protective film 110 is not transparent, the alignment can be conducted from the face side through IR imaging.

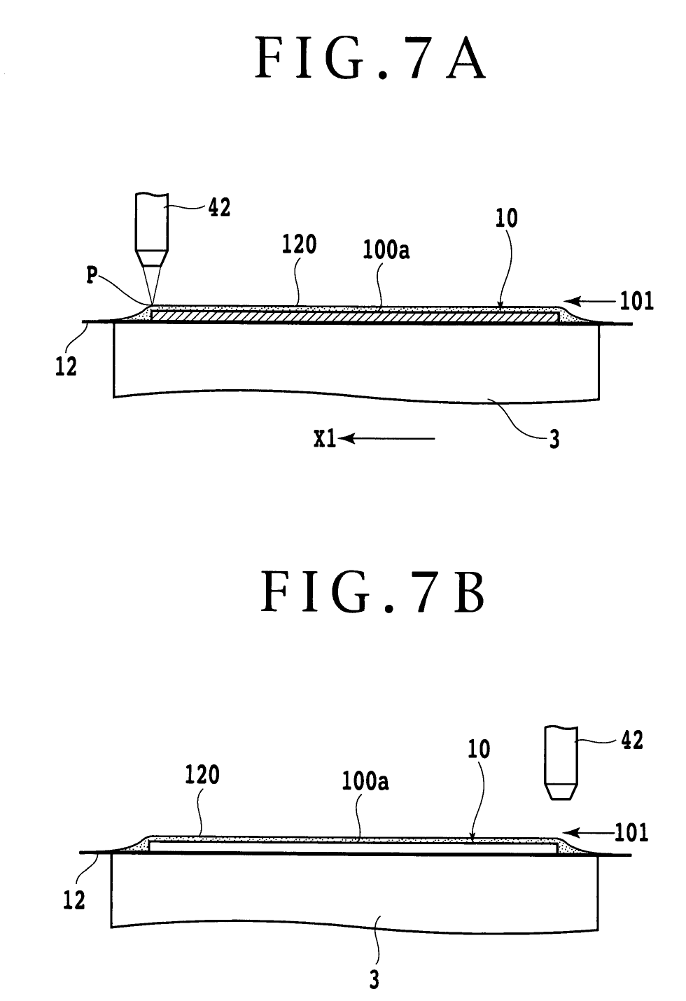

When the planned split lines 101 formed in the gallium arsenide wafer 10 held on the chuck table 3 are detected and the alignment of the laser beam irradiation position is performed in this manner, a laser beam machining step is carried out in which the not-yet-machined gallium arsenide wafer 10 coated with the protective film 120 is irradiated with a laser beam along the planned split lines 101 from the protective film 120 side, and laser beam-machined grooves are formed along the planned split lines 101. Specifically, the chuck table 3 is moved into a laser beam irradiation region where the condenser 42 of the laser beam irradiation means 4 is locate, and a predetermined one of the planned split lines 101 is positioned directly under the condenser 42. In this instance, as shown in FIG. 7A, the semiconductor wafer 10 is so positioned that one end (the left end in FIG. 7A) of the planned split line 101 is positioned directly under the condenser 42. Next, while carrying out the irradiation with a pulsed laser beam via the condenser 42 of the laser beam irradiation means 4, the chuck table 3 is moved at a predetermined machining feed rate in the direction of arrow X1 in FIG. 7A. Then, when the other end (the right end in FIG. 7B) of the planned split line 101 has reached a position directly under the condenser 42 as shown in FIG. 7B, the irradiation with the pulsed laser beam is stopped, and the movement of the chuck table 3 is stopped. In this laser beam machining step, the condensing point (convergent point) P of the pulsed laser beam is matched to the vicinity of the face side 100a of the gallium arsenide wafer 10.

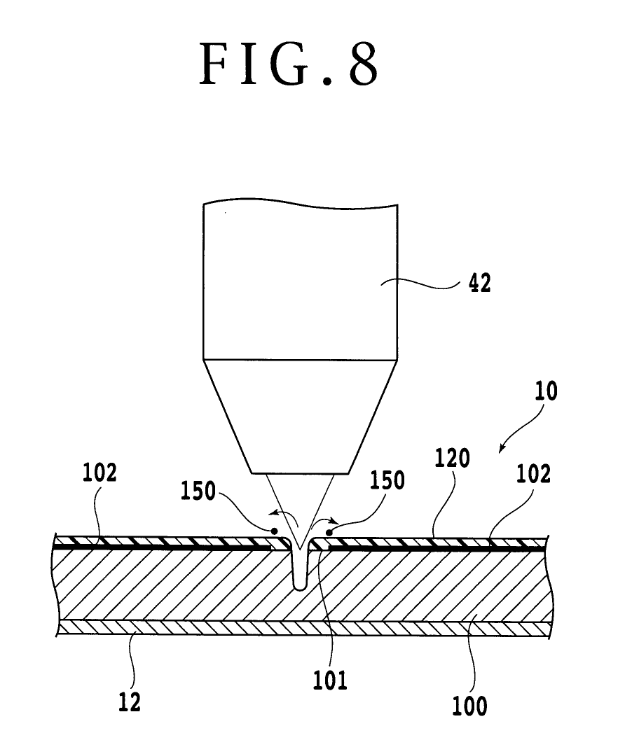

By carrying out the laser beam machining step as above, the gallium arsenide wafer 10 undergoes ablation machining along the planned split line 101, and a laser beam machined groove 140 is formed in the gallium arsenide wafer 10 along the planned split line 101, as shown in FIG. 8. In this case, debris 150 are generated as shown in FIG. 8 upon the irradiation with the laser beam, but the debris 150 are blocked by the protective film 120 and therefore prevented from depositing on the device 102.

Incidentally, the laser beam machining step is carried out, for example, under the following machining conditions.

| | |
|---|---|
| Laser beam source | YVO4 laser or YAG laser |
| Wavelength | 355 nm |
| Repetition frequency | 10 kHz |
| Output | 5 W |
| Condensing spot | elliptic spot; major axis 600 μm, |
| | minor axis 10 μm |
| Machining feed rate | 200 mm/sec |

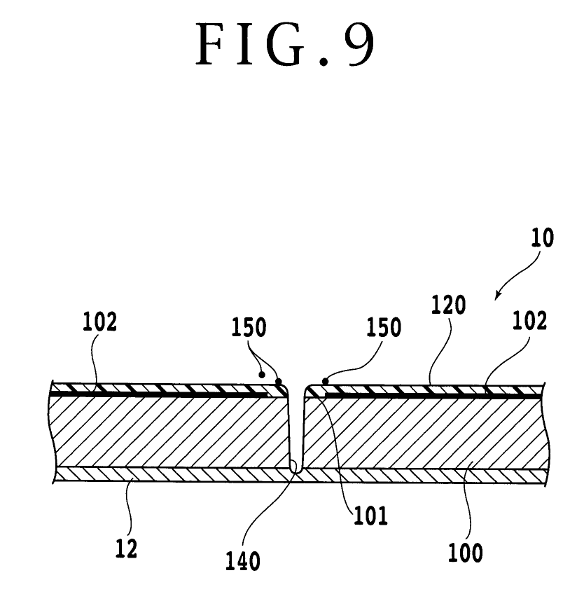

Under these machining conditions, a laser beam machined groove with a depth of about 50 μm can be formed in the gallium arsenide wafer. Therefore, with the laser beam machining step carried out twice along the planned split line 101 in the gallium arsenide wafer 10 having a thickness of 100 μm, a laser beam machined groove 140 reaching the protective tape 12 as shown in FIG. 9 can be formed, and the gallium arsenide wafer 10 can be cut.

When the laser beam machining step as above has been conducted along the planned split lines 101 extending in a predetermined direction of the gallium arsenide wafer 10, the chuck table 3 is turned by 90 degrees, and the laser beam machining step is carried out along the planned split lines 101 extending perpendicularly to the predetermined direction. As a result, the gallium arsenide wafer 10 is cut along the plurality of planned split lines 101 formed in a lattice pattern, and is split into individual devices 102.

When the laser beam machining step as above has been carried out along all the streets 101 in the gallium arsenide wafer 10, the chuck table 3 holding the laser beam-machined gallium arsenide wafer 10 split into the individual devices 102 is returned to the position where the gallium arsenide wafer 10 has initially been held by suction, by an operation of the machining feeding means (not shown), and the holding of the gallium arsenide wafer 10 by suction is released (canceled) there. Then, the gallium arsenide wafer 10 having undergone the laser beam machining is fed by the second wafer feeding means 17 onto the suction chuck 711a of the spinner table 711 constituting the combined etching and cleaning and protective film forming means 7, and is held onto the suction chuck 711a by suction. In this instance, the resin supplying nozzle 741 and the etching liquid nozzle 751 as well as the cleaning water nozzle 761 are positioned in the stand-by positions remote from positions on the upper side of the spinner table 711, as shown in FIGS. 3 and 4.

When the gallium arsenide wafer 10 having undergone the laser beam machining has been held on the spinner table 711 of the combined etching and cleaning and protective film forming means 7, an etching step for etching the peripheral surfaces of the individually split devices 102 is carried out. Specifically, the spinner table 711 is positioned into the working position, and the electric motor (not shown) of the etching liquid supplying means 75 is actuated so that the jet port of the nozzle part 751a of the etching liquid supplying nozzle 751 is positioned to the upper side of a central part of the laser beam machined gallium arsenide wafer 10 held on the spinner table 711. Then, while rotating the spinner table 711 at a rotating speed of 10 rpm, for example, an etching liquid 160 including ammonium hydroxide and hydrogen peroxide is jetted from the jet port of the nozzle part 751a.

With the etching step thus carried out for about 2 min, the etching liquid 160 permeates into the laser beam machined grooves 140 formed along the planned split lines 101 in the gallium arsenide wafer 10, whereby peripheral surfaces of the devices 102 coated with the protective film 120 are etched. As a result, machining strains left in the peripheral surfaces of the devices 102 due to the laser beam machining are removed, so that the devices can be enhanced in transverse rupture strength. Incidentally, the etching liquid used for the etching treatment of the gallium arsenide wafer in the etching step may be an etching liquid including sulfuric acid and hydrogen peroxide, but the use of sulfuric acid is dangerous; therefore, it is desirable to use the etching liquid including ammonium hydroxide and hydrogen peroxide. Thus, the laser beam machining system 1 shown in the figures includes etching means for etching the wafer having undergone the laser beam machining, so that the wafer having been laser beam machined can be etched immediately and efficiently.

When the etching step has been thus performed, a cleaning step for cleaning the etched wafer with water is carried out. Specifically, the etching liquid nozzle 751 is positioned into a stand-by position remote from a position on the upper side of the spinner table 711, as shown in FIGS. 3 and 4, the electric motor (not shown) of the cleaning water supplying means 76 is actuated so as to position the jet port of the nozzle part 761a of the cleaning water supplying nozzle 761 into a position on the upper side of a central part of the gallium arsenide wafer 10 (split into the individual devices 102) held on the spinner table 711. Then, while rotating the spinner table 711 at a rotating speed of 300 rpm, for example, cleaning water including pure water and air is jetted from the jet port of the nozzle part 761a. Incidentally, the nozzle part 761a is composed of a so-called two-fluid nozzle, and is supplied with pure water at a pressure of about 0.2 MPa and with air at a pressure of about 0.3 to 0.5 MPa, whereby pure water is jetted under the pressure of air, thereby cleaning the gallium arsenide wafer 10. In this instance, an electric motor (not shown) is actuated so that the nozzle part 761a of the cleaning water supplying nozzle 761 is swung in a predetermined angular range from a position where the cleaning water jetted from the jet port of the nozzle part 761a collides on the center of the semiconductor wafer 10 held on the spinner table 711 to a position where the jetted cleaning water collides on a peripheral part of the spinner table 711. As a result, the protective film 120 covering the surfaces of the individual devices 102 obtained through splitting of the gallium arsenide wafer 10 can be easily washed away, since the protective film 120 is formed of water-soluble polyvinyl alcohol as above-mentioned, and, simultaneously, the debris 150 generated upon the laser beam machining are also removed.

When the above-mentioned cleaning step is finished, a drying step is carried out. Specifically, the cleaning water supplying nozzle 761 is positioned into the standby position, and the spinner table 711 is rotated, for example, at a rotating speed of 3000 rpm for about 15 sec. When the cleaning and drying of the etched gallium arsenide wafer 10 as above are finished, the rotation of the spinner table 711 is stopped. Then, the spinner table 711 is positioned into the work feeding-in/feeding-out position shown in FIG. 3, and the suction holding of the gallium arsenide wafer 10 held on the spinner table 711 is released (canceled). Next, the machined gallium arsenide wafer 10 on the spinner table 711 is fed out by the first wafer feeding means 16 to the aligning means 14 disposed in the temporary placing part 14a. The machined gallium arsenide wafer 10 fed out to the aligning means 14 is contained into a predetermined position in the cassette 13 by the wafer feeding-out/feeding-in means 15.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser beam machining system comprising:
a chuck table for holding a wafer;
laser beam irradiation means for irradiating said wafer held by said chuck table with a laser beam;
machining feeding means for relative machining feed of said chuck table and said laser beam irradiation means;
indexing feeding means for relative indexing feed of said chuck table and said laser beam irradiation means in a direction orthogonal to the direction of said machining feed;
etching means for etching said wafer having undergone laser beam machining; and
feeding means for feeding said laser beam machined wafer held by said chuck table to said etching means.

2. The laser beam machining system as set forth in claim 1, wherein said etching means includes
a spinner table for holding and spinning said wafer, and
etching liquid supplying means for supplying an etching liquid to said laser beam machined wafer held by said spinner table.

3. The laser beam machining system as set forth in claim 2, wherein said etching means has
protective material supplying means for supplying a protective material liquid for forming a protective film on the side to be machined of said wafer not yet laser beam machined which is held by said spinner table.

4. The laser beam machining system as set forth in claim 2, wherein said etching means has
cleaning water supplying means for supplying cleaning water for cleaning said etched wafer held by said spinner table.

5. The laser beam machining system as set forth in claim 1, wherein said wafer is a gallium arsenide (GaAs) wafer, and said etching liquid used for etching by said etching means includes ammonium hydroxide and hydrogen peroxide.
